(19) United States
(12) Patent Application Publication
(10) Pub. No.: US 2011/0230289 A1
(43) Pub. Date: Sep. 22, 2011

(54) DOUBLE-SIDED INVERTED TOOTH CHAIN

(75) Inventors: Bolko SCHUSEIL, ADELSDORF (DE); Lucian BOTEZ, NOVI, MI (US)

(73) Assignee: SCHAEFFLER TECHNOLOGIES GMBH & CO. KG

(21) Appl. No.: 13/046,243

(22) Filed: Mar. 11, 2011

Related U.S. Application Data
(60) Provisional application No. 61/315,044, filed on Mar. 18, 2010.

(51) Int. Cl. F16G 13/07

(52) U.S. Cl. 474/206

(57) ABSTRACT

The double-sided inverted tooth chain has inner link plates and middle link plates, which have teeth projecting in both a first direction and a second direction and a pair of pin holes. Also, the double-sided inverted tooth chain has outer link plates, which also contain pin holes, that are fixed to the inner link plates and the middle link plates by pins fitted into the pin holes of the link plates, forming an endless loop.

### FIELD OF INVENTION

The present invention relates to power transmission mechanisms and more particularly to double-sided inverted tooth chains for use in internal combustion engines.

### BACKGROUND OF THE INVENTION

Inverted tooth (IT) chains (silent chains) are typically used for power transmissions in internal combustion engine applications, including timing drive, oil pump drive and balancer drive applications. Generally, double-sided inverted tooth chains are derived from single-sided chains by incorporating few additional reversed tooth link plates. Chains designed in this manner are usually highly over-dimensioned because they are double the width and weight of a single-sided chain.

Double-sided chains are known, see, for example, U.S. Pat. No. 6,334,829, which discloses a double-meshing-type silent chain drive, which includes link plates that have identical side profiles. The link plates each have two meshing teeth and a flat back face formed opposite the meshing teeth. The link plates arc alternatively arranged such that the meshing teeth of one link plate faces outwardly and the meshing teeth of an adjacent link plate face inwardly. This chain drive requires additional tooth plates on each side, creating a wider or more over-dimensioned chain.

Additionally, see, for example, U.S. Pat. No. 6,142,902, which discloses a double-meshing-type silent chain, which includes link plates that have identical side profiles. The link plates each have two meshing teeth and a flat back face formed opposite the meshing teeth. The link plates are alternatively arranged on opposite directions in the longitudinal direction of the chain, while the adjacent link plates are connected by pins. This chain drive requires additional tooth plates on each side, creating a wider or more over-dimensioned chain.

Moreover, see, for example, U.S. Patent Application No. 2005/0277507, which discloses a double-sided silent chain, which has teeth on each link plate protruding in one direction. The inner link plates facing one direction are fixed to outer link plates facing an opposite direction. Again, this chain drive requires additional tooth plates on each side, creating a wider or more over-dimensioned chain.

### SUMMARY OF THE INVENTION

The present invention is directed to a double-sided IT chain that has the same width and approximately the same weight as a single-sided chain, while maintaining the same chain strength and wear resistance. The sprocket, unlike the prior art references, is identical to the design required for a single-sided chain. Additionally, only minor changes are required to the single-sided chain assembly in order to accommodate the assembly of the double-sided IT chain.

The double-sided IT chain has inner link plates, middle link plates, and outer link plates, which use the same lacing as a single-sided chain. The tooth profile of the inner link plates and the middle link plates are symmetrical and minored about a centerline passing through the centers of the link plate apertures (pin holes). In order to avoid unwanted contact between the tooth tips of the link plates and the chain guide system, the contour of the outer link plates is also mirrored along a centerline passing through the centers of the pin holes so that the contour of the outer link plates is symmetric. Utilizing symmetric inner link plates, middle link plates, and outer link plates, the double-sided IT chain maintains the same lacing and the same chain width, with only minimal weight increase, as a single-sided chain.

Alternatively, the tooth profiles of the inner link plates and the middle link plates are asymmetric about a centerline passing through the centers of the link plate apertures (pin holes). In order to avoid unwanted contact between the tooth tips of the link plates and the chain guide system, the contour of the outer link plates is mirrored along a centerline passing through the centers of the pin holes so that the contour of the outer link plates is symmetric. Utilizing the combination of inner link plates, middle link plates, and outer link plates, the double-sided 11 chain maintains the same lacing and the same chain width, with only minimal weight increase, as a single-sided chain.

Additionally, in order to maintain the strength of the double-sided IT chain at a level similar to a single-sided chain, the ratio between the crotch dimension (C) and the pitch dimension (P) of the double-sided IT chain is greater than or equal to 0.15. Additionally, in order to maintain the strength of the double-sided IT chain at a level similar to a single-sided chain, the ratio between the crotch dimension (C*) and the pitch dimension (P) of the double-sided IT chain is greater than or equal to 0.15.

Single-sided chains are known to have a curved profile on the lower portion of the outer link plate. This design maximizes clearance between the sprocket hub and the chain outer link plate, resulting in a more robust sprocket design. However, the curved profile is only disclosed in prior art references on one side of the outer link plate. In an alternative embodiment, the outer link plate is symmetrically designed. Both the upper portion and lower portion of the outer link plate are concavely curved in an identical manner toward a centerline. Thus, the upper portion and the lower portion have curved surfaces that minor each other.

In another configuration of the outer link plate, the lower portion of the outer link plate is identical to the single sided version, having a slightly inwardly curved surface, while the upper portion is straight or slightly convex, providing favorable contact between the upper surface of the outer plate and the chain guide system. In this embodiment, the distance from the centerline and the upper portion of the outer link plate (H) is greater than or equal to the distance between the centerline and the tip of the corresponding tooth plate (H*).

Moreover, in addition to a 3×2 lacing with a press-fit middle link plate, the claimed invention can be applied to other lacings, as well as for chains without press-fitted tooth link plates.

Broadly, the present invention can be defined as a double-sided IT chain that comprises inner link plates, middle link plates, outer link plates, and pins. The inner link plates and the middle link plates each have a pair of pin holes, a pair of link teeth which project in a first direction and a pair of link teeth which project in a second direction. Each outer link plate has a pair of pin holes. The pins extend through the pin holes of the outer link plates, the middle link plates and the inner link plates, fastening the outer link plates, the middle link plates and inner link plates to each other and forming an endless loop.

In one embodiment, the pair of link teeth that project in a first direction and in a second direction minor each other and are identical.

In another embodiment, the pair of link teeth project in a first direction and the pair of link teeth projecting in a second direction are asymmetrical.

Additionally, a ratio between a lower crotch dimension and a chain pitch is greater than or equal to 0.15 (C/P≧0.15).

Additionally, a ratio between an upper crotch dimension and a chain pitch is greater than or equal to 0.15 (C*/P≧0.15).

Additionally, each outer link plate has a lower portion, projecting in a first direction and an upper portion projecting in a second direction. in one embodiment, the lower portion and the upper portion of the outer link plates are each curved inwardly toward a centerline of the outer link plates. In another embodiment, the lower portion of the outer link plates is curved inwardly toward a centerline of the outer link plates and the upper portion of the outer link plates is flat or slightly convex. In yet another embodiment, the lower portion of the outer link plates is flat or slightly convex and the upper portion of the outer link plates is flat or slightly convex.

Additionally, the distance from the pin holes of the outer link plates and the upper portion of the outer link plates is greater than or equal to the distance between the pin holes and tips of the links of a corresponding tooth inner link plate or middle link plate.

Additionally, the pins are press fit into an aperture of the middle plates.

Alternatively, the outer link plate, the inner link plates, and a middle link plate are arranged in a 3×2 lacing. Other lacing configurations are also possible.

### BRIEF DESCRIPTION OF THE DRAWINGS

The present invention will be further understood and appreciated by reading the following description in conjunction with the accompanying drawings, in which:

FIG. 1 is a side view illustrating a single-sided link plate;

FIG. 2 is a side view illustrating a double-sided link plate;

FIG. 3 is a side view illustrating an alternate embodiment of a double-sided link plate

FIG. 4 is a side view illustrating a single-sided chain outer plate;

FIG. 5 is a side view illustrating a double-sided chain outer plate;

FIG. 6 is a side view illustrating the ratio between the dimension and pitch of the double-sided chain;

FIG. 7 is a side view illustrating a single-sided outer plate;

FIG. 8 is a side view illustrating an alternative embodiment of a double-sided outer plate;

FIG. 9 is a top view illustrating an alternative embodiment of a double-sided outer plate;

FIG. 10 is a side view illustrating Detail A of the double-sided IT chain;

FIG. 11 is a top view illustrating the double-sided IT chain; and

FIG. 12 is a side view illustrating the double-sided IT chain in an assembled state.

### DETAILED DESCRIPTION OF THE INVENTION

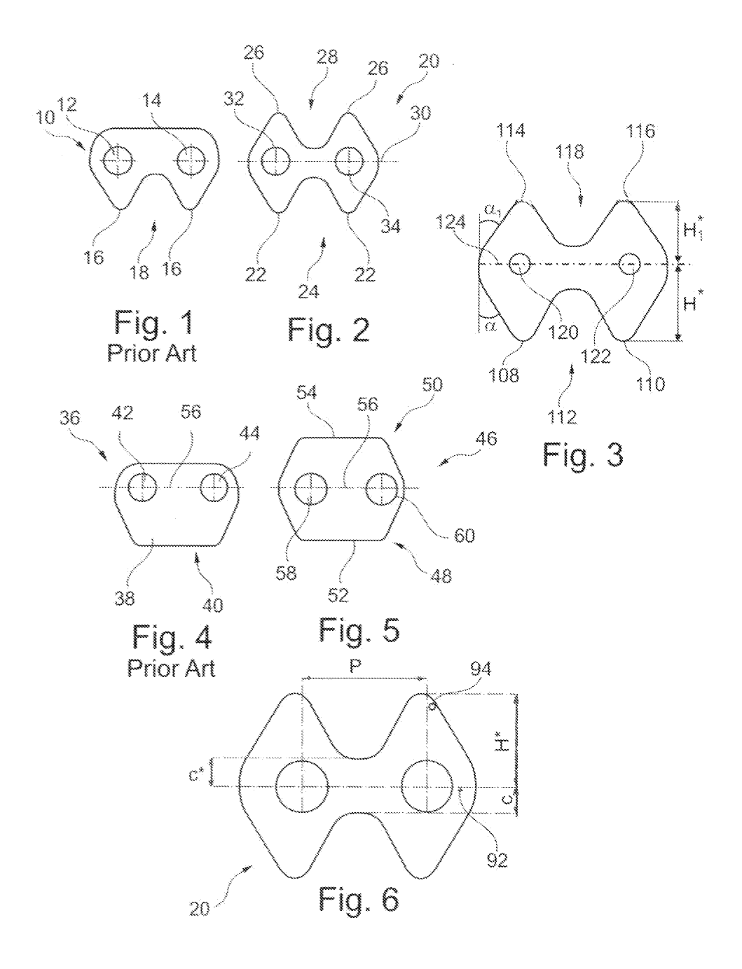

Referring now to the drawings, in which like reference numerals refer to like reference parts throughout, FIG. 1 shows a side view of a known single-sided link plate 10 having pin holes 12, 14 and teeth 16 projecting toward the lower portion 18 of the single-sided link plate 10.

FIG. 2 shows a double-sided link plate 20, which has teeth 22 projecting toward the lower portion 24 and teeth 26 projecting toward an upper portion 28. The teeth 22, 28 located on both the lower portion 24 and the upper portion 28, mirror each other along a centerline 30. Two pin holes 32, 34 are located along the centerline 30 as well.

FIG. 3 shows a double-sided link plate 106, which has teeth 108, 110 projecting toward the lower portion 112 and teeth 114, 116 projecting toward an upper portion 118. The teeth 108, 110, 114, 116 are located on both the lower portion 112 and the upper portion 118, are asymmetrical. This asymmetric geometry may be accomplished in multiple ways. For example, the height H₁* of the double-sided link plate 106 from the centerline 124 to the teeth 114, 116 is not equal to the height H* of the teeth 108, 110, and the angle a of the teeth 108, 110 and the angle α₁ of the teeth 114, 116 is not equal. Additionally, two pin holes 120, 122 are located along a centerline 124.

FIG. 4 shows a known outer link plate 36 design for a single-sided chain, which has a contour 38 on the lower portion 40 of the outer link plate 36 and pin holes 42, 44.

FIG. 5 shows an outer link plate 46 with a lower portion 48 and the upper portion 50 having the same contour 52, 54, which are mirrored along a centerline 56. The outer link plate 46 also has two pin holes 58, 60 located along the centerline 56.

FIG. 6 shows a side view of the double-sided link plate 20. The figure shows the ratio between the crotch dimension (C) and (C*) and the pitch dimension (P). In order to maintain a strength similar to a single-sided link plate 10, the ratio between the crotch (C) and the chain pitch (P) is greater than or equal to 0.15 (C/P≧0.15). Additionally, the ratio between the crotch (C*) and the chain pitch (P) is greater than or equal to 0.15 (C*/P≧0.15).

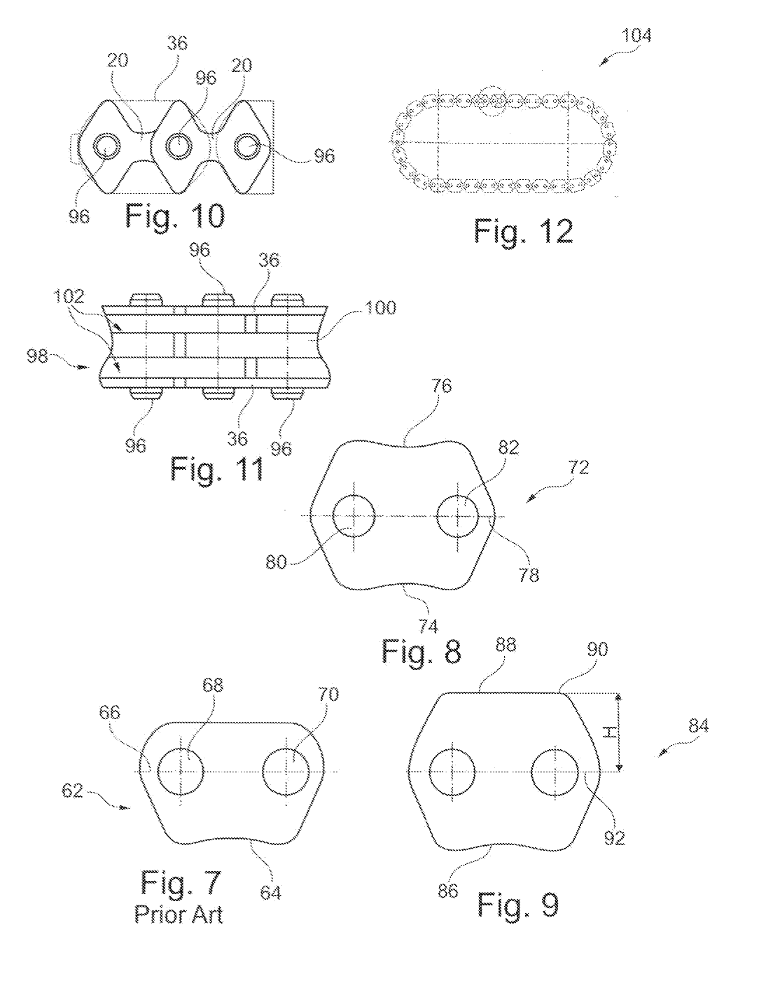

FIG. 7 shows a known single-sided outer link plate design 62. The lower portion 64 of the single-sided outer link plate 62 is curved inward, toward a centerline 66, and two pin holes 68, 70 are located along the centerline 66.

FIG. 8 shows an alternate embodiment of an outer link plate 72. Here, both the lower portion 74 and upper portion 76 of the outer link plate 72 have an inwardly curved surface toward a centerline 78. The outer link plate 72 has two pin holes 80, 82 also located along the centerline 78. The curved surface on both the lower portion 74 and the upper portion 76 maximizes clearance to a sprocket hub irrespective of the location of the sprocket hub.

FIG. 9 shows another alternative embodiment of the outer link plate 84. The lower portion 86 of the outer link plate 84 is identical to the single-sided outer link plate design 62 disclosed in FIG. 6. The upper portion 88 of the outer link plate 84 has a straight or slightly convex surface 90 in order to maintain favorable contact between the outer link plate's upper surface 88 and the chain guiding system (not shown). The distance from the centerline 92 and the upper portion 88 of the outer link plate H must be greater than or equal to the distance between the centerline 92 and the link tips 94 of the corresponding tooth plate H* (see, FIG. 6).

FIG. 10 shows a side view of the double-sided link plate 20 connected to the outer link plates 36 by pins 96.

FIG. 11 shows a top view of the double-sided chain 98 in an assembled state with a 3×2 lacing with a press-fit middle link plate 100. Pins 96 are fitted between the outer link plates 36, inner link plate 102, and middle link plate 100 to secure the link plates 100, 102, 36 together. Together, the inner link plates 100 and middle link plate 102 are double-sided link plates 20. However, it is not required that the middle link plate 100 be press-fit. The outer link plates 36 must always be press-fit to the pins 96. The middle link plate 100, depending on the application, can be press-fit or have clearance with the pins 96, while the inner link plates 102 must always have clearance with the pins 96.

FIG. 12 shows a side view of a full double-sided chain assembly 104.

The present invention has been described with reference to a preferred embodiment. It should be understood that the scope of the present invention is defined by the claims and is not intended to be limited to the specific embodiment disclosed herein.

What is claimed:

1. A double-sided IT chain, comprising:
inner link plates;
middle link plates;
outer link plates; and
pins,
the inner link plates and the middle link plates each having a pair of pin holes, a pair of link teeth projecting in a first direction and a pair of link teeth projecting in a second direction,
each outer link plate having a pair of pin holes; and
the pins extending through the pin holes of the outer link plates, the middle link plates and the inner link plates, so as to fasten the outer link plates, the middle link plates and inner link plates to each other, forming an endless loop.

2. The double-sided IT chain, wherein the pair of link teeth projecting in the first direction and the pair of link teeth projecting in the second direction mirror each other and are identical.

3. The double-sided IT chain, wherein the pair of link teeth projecting in the first direction and the pair of link teeth projecting in the second direction are asymmetrical.

4. The double-sided IT chain of claim 1, wherein a ratio between a chain pitch dimension and a lower crotch dimension is greater than or equal to 0.15.

5. The double-sided IT chain of claim 1, wherein a ratio between a chain pitch dimension and an upper crotch dimension is greater than or equal to 0.15.

6. The double-sided IT chain of claim 1, wherein each outer link plate has a lower portion, projecting in a first direction and an upper portion projecting in a second direction.

7. The double-sided IT chain of claim 6, wherein the lower portion and the upper portion of the outer link plates are curved inwardly toward a centerline of the outer link plates.

8. The double-sided IT chain of claim 6, wherein the lower portion of the outer link plates is curved inwardly toward a centerline of the outer link plates and the upper portion of the outer link plate is flat or slightly convex.

9. The double-sided IT chain of claim 6, wherein the lower portion of the outer link plates is flat or slightly convex and the upper portion of the outer link plates is flat or slightly convex.

10. The double-sided IT chain of claim 6, wherein a distance from the pin holes of the outer link plates and the upper portion of the outer link plates is greater than or equal to the distance between the pin holes and tips of the links of a corresponding tooth inner link plate or middle link plate.

11. The double-sided IT chain of claim 10, wherein the pins are press-fit into apertures of the middle link plates.

12. The double-sided IT chain of claim 1, wherein the outer link plates, the inner link plates, and a middle link plate are arranged in a 3×2 lacing.
